(19) United States
(12) Patent Application Publication
(10) Pub. No.: US 2006/0070527 A1
(43) Pub. Date: Apr. 6, 2006

(54) Autonomic method to filter air in a digital hardware system

(75) Inventors: Cory Allen Chapman, Raleigh, NC (US); Albert Vincent Makley, Raleigh, NC (US); Kenneth Scott Seethaler, Raleigh, NC (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/959,836

(22) Filed: Oct. 6, 2004

(51) Int. Cl. B01D 46/00

(52) U.S. Cl. 96/417; 96/429

(57) ABSTRACT

Methods and arrangements for autonomic filter replacement are disclosed. In a digital hardware system, a filter supply mechanism is provided that contains a supply of filter material. A filter collection mechanism is also provided. The supply and collection mechanisms are positioned such that an area of filter is spread across an air intake through which air is drawn by a fan. An electronically controlled drive mechanism is provided to drive the filter collection mechanism in response to a condition indicative of filter use. In response to the condition, a length of unused filter material is drawn from the supply and a corresponding length of used filter material is collected to cause unused filter material to be spread across the air intake.

### FIELD OF INVENTION

The present invention is in the field of filtering dust and other particulate matter in a digital hardware system. More particularly, the present invention relates to methods and arrangements to filter air at an air intake to an enclosed digital hardware system such as a computer or server.

### BACKGROUND

Personal computers systems and other digital processing systems have achieved very high levels of processing power and performance despite relatively small size. This high level of compact performance is accomplished partially through the use of high density integrated circuit packages. High density integrated circuit packages use a significant amount of electricity and generate high levels of localized heat within the digital hardware housing. The heating problem is exacerbated as more and more components are placed on a single chip, each component possibly contributing to the heating problem. Power densities, as measured by watts per square foot of board space (or watts per cubic foot of cabinet space), continue to increase as processors and associated components consume greater and greater amounts of power. The more wattage consumed by a given component, the greater the heat output by that component and the higher the temperature given a constant amount of cooling. As component temperatures rise, the risk of thermal failure (such as due to excessive thermal expansion) rises as well.

To combat the heating problem, computer systems attempt to dissipate the heat away from key or vulnerable components. One common way of dissipating heat is to flush it out through the use of fans and heat sinks. Heat sinks, which are typically made of a metallic material, pull generated heat away from a component. Fans draw air from the exterior of a cabinet housing digital hardware and blow the air over the heat sinks so that heat is extracted from the heat sink to the air, and the air (with extracted heat) is then directed outside of the computer system.

Heating problems are often exacerbated when large numbers of digital hardware systems are brought together in one centralized location. One example where this occurs is in a Central Office of a telephone communications network. Another example is the consolidation by many organizations of servers into centralized data centers. This is done to achieve physical, application, or data consolidation as a means of reducing the challenges and costs associated with administering many small servers scattered across an enterprise. To date, physical consolidation has generally involved replacing bulky tower servers with slender 1U or 2U rack systems. The slender rack systems take less space and the servers and infrastructure are within easy reach of the administrator, rather than spread across a large campus.

The trend toward consolidation has led to even more compact server arrangements such as blade servers. A blade server, e.g., IBM eServer BladeCenter, is a type of rack-optimized server that provides an effective alternative to 1 U and 2U servers. Blade server designs range from ultra-dense, low-voltage, lesser-performing servers to high-performance, lower density servers to proprietary, customized rack solutions that include some blade features.

These systems enable organizations to reap many benefits of consolidation. However, by placing multiple heat generating sources in close proximity, thermal loads can be even more of a problem as servers transfer heat to nearby servers, and airflows become more complicated and restricted. The compactness of systems like blade servers forces otherwise independent servers to share a thermal profile with hardware resources, including enclosures, power supplies, fans, and management hardware, causing power consumption and cooling to become much more critical.

Thus, in such systems, multiple fans are provided for cooling various sections of the hardware and multiple temperature sensors in various locations may also be provided as well. Where each fan is used, air is drawn by the fan into the cabinet that houses the hardware to cool the hardware therein. An air intake for each fan is provided by, for example, perforating an area on a side of the cabinet, or by providing a hole and a grill. The fan is mounted interior to the cabinet to draw air through the perforated area or grill. A filter may be provided that is mounted interior to the cabinet between the fan and the air intake. Without a filter, dust is drawn into the cabinet, potentially leading to degraded hardware performance or even catastrophic failure. After so many hours of usage a filter becomes dirty and clogged and should be replaced. This requires removing a panel section of the cabinet in order to gain access to the filter. Failure to replace a clogged or dirty filter will cause the hardware to operate at a higher temperature because less air will be drawn through the filter into the interior of the cabinet. Operating at a higher temperature may hasten hardware failure. Thus, frequent filter replacement is needed.

As noted, in large networks large numbers of digital hardware modules are cooled by multiple fans. Each fan draws air through a separate filter. Filter maintenance must be scheduled and can be time consuming. Moreover, filter maintenance is commonly inefficient because filters are sometimes replaced too often and sometimes not often enough. Thus, on the one hand filter material is being wasted and on the other hand hardware operation is jeopardized. Since filter material is relatively cheap compared to hardware failure, filter replacement may be scheduled more frequently, consuming labor. Moreover, some digital hardware units draw more power than others for a variety of reasons. Some units will therefore heat up faster for a given extent of filter blockage. Such units may therefore require filter replacement more frequently than other units, increasing the inconvenience and inefficiency of maintenance scheduling.

What is desired is an autonomic solution that automatically provides an unused filter when an existing filter becomes dirty. More particularly, what is needed is automatic filter replacement in response to a condition indicative of filter use so that time spent by humans on filter maintenance is reduced or even eliminated.

### SUMMARY OF THE INVENTION

The present invention provides autonomic methods and apparatus to filter air in a digital hardware system. According to one aspect of the present invention, air that flows through an air intake into the interior of a cabinet that houses digital hardware is filtered by a length of filter material supplied by a supply mechanism. The filter material leaves the supply mechanism, passes across the air intake and is collected by a collection mechanism. A drive mechanism drives the filter collection mechanism causing filter material to move past the air intake and be collected by the filter collection mechanism.

According to another aspect of the invention, one or more parameters indicative of filter use are monitored. The parameters are observed and processed and a signal is generated based upon a value of a parameter associated with replacing the filter material. In response to the signal, a filter is driven to collect a used filter material and to position an unused filter material across a path for the air from the air intake. This attenuates an accumulation that restricts heat dissipation from the digital hardware.

According to yet another aspect of the invention, a system for replacing filter material across an air intake of a cabinet for digital hardware includes a filter mechanism, sensors and a processor. The filter mechanism is located near the air intake and positions a length of a filter material across an air path to capture particulates in the air and to replace used lengths of the filter material in response to a replacement signal. The sensors are distributed within the cabinet and provide measurements of conditions there within. The processor is coupled to the sensors and receives and processes the sensor measurements to determine when to replace the length of the filter material. The processor also generates the replacement signal to instruct the filter mechanism to replace the length of the filter material. In a more complex embodiment, multiple sets of sensors are distributed about different sets of hardware modules located in different cabinets. The sensors are monitored by a processor and multiple filters distributed among the cabinets and throughout the room housing the cabinets are controllable in response to the signals from the sensors.

According to another aspect of the invention, the drive mechanism drives a filter collection mechanism in response to a drive control signal. The drive control signal is generated when measurement of one or more parameters indicative of filter use indicates that the filter is to be replaced. Thus, in one embodiment, the drive control signal is generated when at least a portion of the digital hardware within the cabinet has been operating for a predetermined amount of time. Or, the control signal can be generated if a given level of power consumption has occurred. In another embodiment, the control signal is in response to air pressure measurements. Or the control signal can be in response to temperature measurements. Generally, the control signal may be generated in response to a combination of the conditions observed by the sensors. The drive control signal causes the drive mechanism to drive the filter collection mechanism until a predeterminable length of filter material is collected. Thus, used filter material is collected and a length of unused filter material is pulled across the air intake.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a system including a monitoring device to determine whether filter material should be replaced;

FIG. 2 depicts an example of a flow chart showing operation of an embodiment of the invention.

FIG. 3 depicts a more detailed view of a monitoring device in an embodiment of the invention.

FIG. 4 depicts a system embodiment of the invention.

FIG. 5 depicts an alternative configuration of a system embodiment of the invention.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

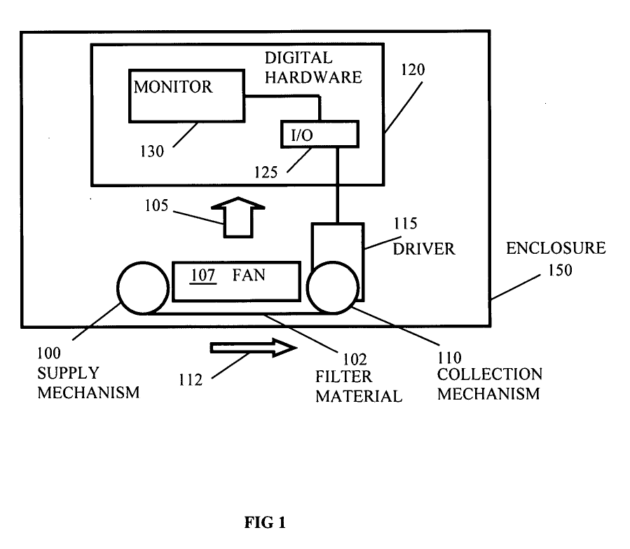

An embodiment of the present invention is shown in FIG. 1. A cabinet 150 houses digital hardware 120 which comprises a monitoring mechanism 130 and an Input/Output (IO) device 125. Digital hardware 120 typically comprises multiple hardware elements such as a central processing unit (CPU) and associated volatile and non-volatile memory, including random access memory (RAM) and basic input/output system read only memory (BIOS ROM) or firmware, disk storage and network controllers as well as other hardware elements.

As will be discussed in more detail below, monitoring mechanism 130 monitors one or more values obtained from one or more sensors and determines if a condition exists warranting filter replacement. IO device 125 receives a signal from monitoring mechanism 130 when it is time for filter replacement. In response to the received signal 10 device 125 sends a signal to a drive mechanism 115 housed within enclosure 150. In response, drive mechanism 115 causes the filter to advance as will be more fully described below.

Enclosure 150 also houses a filter supply mechanism 100, a filter collection mechanism 110 and a fan 107. Filter supply mechanism 100 contains a supply of unused filter material. Filter collection mechanism 110 collects used filter material. Fan 107 operates to draw air through an air intake (not shown) so that air flows generally in the direction shown by the arrow 105. This air flow removes heat from digital hardware 120. Air moved by fan 107 is drawn through filter material 102. The filter material across the air intake collects dust and particulate matter from the air. Any suitable filter material now known or to be developed may be employed.

In one embodiment, the filter material is supplied from a roll of filter material wrapped onto a spool of filter supply mechanism 100. Drive mechanism 115, in response to a signal received from IO device 125, causes collection mechanism 110 to rotate. When collection mechanism 110 rotates, filter material moves in the direction shown by arrow 112 and wraps onto a spool of collection mechanism 110 and unwraps from filter supply mechanism 100. In this way, used filter material is collected and unused filter material is drawn across the air intake.

The drive control signal that actuates drive mechanism 115 is generated in response to a condition indicative of use of the filter material presently across the air intake. Thus, in one embodiment monitor 130 comprises a counter to indicate a lapse of time. The count continues while the system is in operation. The count is compared to a threshold and the count continues until the threshold amount of time has elapsed. When the threshold has been reached, a drive signal is generated to advance the filter. In another embodiment, monitor 130 comprises a parameter analyzer to compare the current power usage to a threshold power usage level stored in memory. When the power used exceeds the threshold, a drive signal is generated to advance the filter. Monitoring mechanism 130 may be implemented as application-specific circuitry or be implemented in hardware operating under the direction of software. IO device 125 may be implemented by use of a General Purpose Input/Output (GPIO) device.

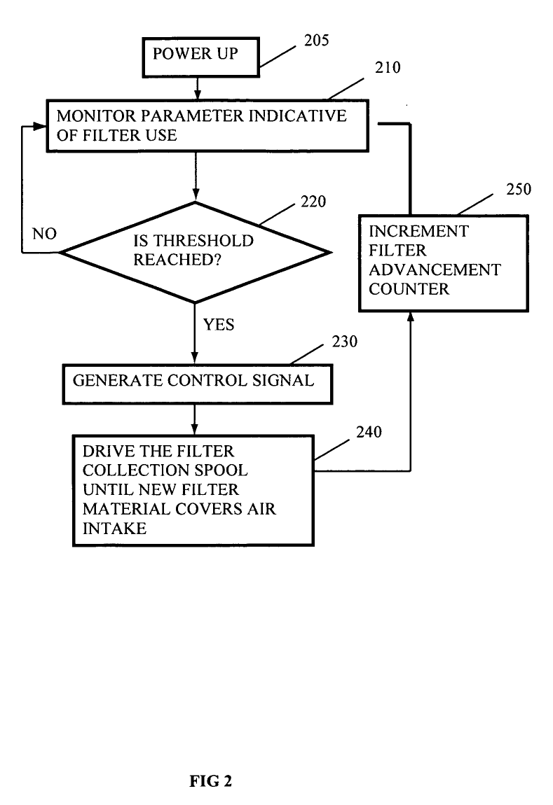

Operation of an embodiment of the present invention is illustrated by the flow chart in FIG. 2. When the digital hardware system is powered on 205, it is monitored 210 to determine from sensors within housing 150 a parameter indicative of filter use. Such parameters include an elapsed time of operation, an amount of power usage, temperature, air pressure and fan speed. Monitor 130 processes the sensed value and produces one or more parameters indicative of filter use. A control signal is generated 230 when one or more of the parameters reaches a threshold 220. This control signal is transmitted to the drive mechanism. In response, the drive mechanism drives the filter collection spool until a length of unused filter material covers the air intake 240. Then, a counter that counts the number of times the filter has been advanced is incremented 250, and then monitoring continues 210.

Thus, an embodiment of the invention filters air that flows through an air intake to communicate filtered air to the interior of a cabinet that houses digital hardware. The embodiment comprises a filter supply mechanism that supplies a length of filter material and a filter collection mechanism to collect the filter material. A monitor determines one or more conditions indicative of filter use and a signal is generated when filter replacement is due. A drive mechanism responsive to the signal drives the filter collection mechanism to collect used filter material and to draw unused filter material across an air passage in response to a condition indicative of filter use.

As noted, as an alternative to measuring an elapsed time, the counter may measure an amount of power consumption of at least part of the digital hardware in the system. For example, system BIOS may compute the power consumed by a microprocessor in a computer. Monitor 130 may monitor power consumption by digital hardware 120 and this information may be used, for example, to increase fan speed for certain operations that require more power to increase the rate of dissipation of heat. But as the filter becomes dirty, less air will flow through it. This will cause an increase in temperature of the digital hardware. Consequently, more power will be consumed for a given operation. Thus, in an embodiment of the present invention, monitoring mechanism 130 integrates power consumption during a given operation over a time interval. This integral is used to determine whether the power consumption over time exceeds a threshold indicating the filter needs to be advanced. Clearly, different embodiments can use different parameters for indicating a time of filter replacement.

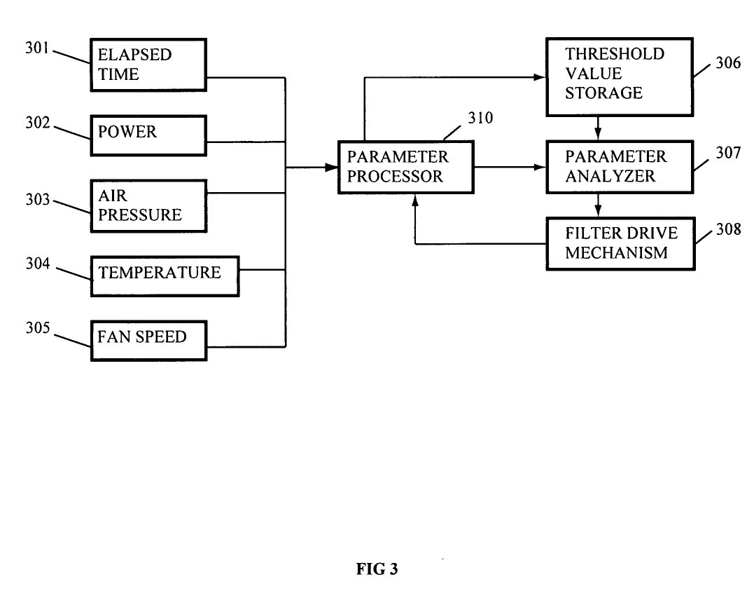

FIG. 3 depicts a more detailed view of a monitoring process in an embodiment of the present invention. A parameter processor 310 receives signals from one or more sensors. Shown as examples are sensors to determine a value for elapsed time 301, power 302, air pressure 303, temperature 304, and fan speed 305. Elapsed time sensor 301 may be implemented as a counter that counts when a digital hardware system or some portion thereof is powered on. Power sensor 302 may be implemented as measurement circuitry of the instantaneous power consumed by the digital hardware or portion thereof. An air pressure sensor 303 may be placed in the path of air flow through the filter to sense the pressure of air being drawn through the filter material 102. Fan speed 305 is determined from the signal applied to the fan or the high/low state of a fan control signal.

Note that a plurality of each type of sensor may be employed. Then, parameter analyzer 307 analyzes parameters derived from the signals from the various sensors to determine which, if any, of a plurality of filters should be advanced. For example, temperature sensors 304 may be placed in different locations within a digital hardware enclosure. Indeed, it is a common practice in the industry to provide internal temperature monitoring and to implement a dual-level threshold scheme to recognize a thermal problem before it develops into a thermal crisis. Air pressure sensors 303 may also be placed in different locations. In this way parameter processor 310 can monitor the output of a plurality of sensors to gain a detailed picture of the conditions of hardware operation in a variety of regions.

A major hardware element near one or more sensors producing unacceptable readings may be assumed to be responsible for those readings, or a more complex determination may be made. For example, the power consumption of different portions of the digital hardware can be combined with data on air pressure and temperature in proximity to the different portions of digital hardware. Then, when a portion of the digital hardware is beginning to draw more power over time, in a region where temperature has increased and air pressure has decreased, the conditions may be determined to exist for advancement of a filter through which the primary air component flows to cool the portion of digital hardware. Thus, processing signals from multiple sensors in multiple locations enables a more intelligent decision whether to advance a particular filter.

The parameter processor 310 receives the one or more sensor signals and determines one or more parameters indicative of filter use. For example, parameter processor 310 may measure an elapse of time since the last filter replacement. Parameter processor 310 may sum the power sensor signals received from a power sensor 302 over an elapsed time to produce an integrated power parameter. The integrated power parameter may then be compared to an expected value. If the measured parameter is greater than the expected threshold value then a condition of excess filter use may exist. Parameter processor 310 may also output an air pressure parameter representing a reduction of air pressure over time. The measured air pressure may then be compared to an expected value of air pressure. If the measured air pressure falls below the expected value then a condition of excess filter use may exist. Parameter processor 310 may also output a temperature parameter representing an increase in temperature over time. The temperature or temperature gradient can then be compared to an expected value to provide another indicator from which a filter replacement decision can be made.

In addition or in the alternative, parameter processor 310 may combine these parameters in a formula, or may evaluate these parameters according to a set of rules, to produce a single composite parameter. For example, a composite parameter may be a weighted sum of parameters derived from the sensors. Thus, monitoring system 130 provides one or more parameters indicative of filter use. In one embodiment parameter processor 310 computes the ratio of temperature to air pressure. This ratio may be compared to a threshold value so that when the computed ratio of measured parameters exceeds the threshold, a decision to advance the filter may be made.

In another embodiment, processor 310 averages over a time interval the power consumed by a portion of the digital hardware while performing a given function. This data is logically combined with air pressure measurements. If the average power consumed exceeds an expected value and air pressure drops below a certain level, a decision to advance the filter is made. In another embodiment, when temperature rises to a threshold level, fan speed is caused to increase to increase the velocity of air flowing through the interior of a hardware enclosure. Parameter processor 310 then monitors the resultant temperature and air pressure distribution, as determined from the sensors, to determine if filter replacement is warranted. In yet another embodiment, the command to advance the filter may occur at the earlier of an elapsed time or the occurrence of power consumption exceeding a threshold level.

Parameter analyzer 307 receives the one or more parameters and compares them to corresponding threshold parameters stored in memory 306. The threshold value, or values, may be fixed or dynamically adjusted. For example, threshold storage may provide a fixed threshold value of elapsed time. As another example, if temperature is high, parameter processor 310 may raise the threshold value for air pressure to cause the filter to be replaced sooner when air pressure falls below the updated threshold air pressure value. Thus, parameter analyzer 307 accesses fixed or dynamic threshold values stored in memory 306 and compares them to parameters indicative of filter use, as determined by parameter processor 310.

In response to comparisons made by parameter analyzer 307, a decision is made whether to advance the filter, to continue monitoring and processing sensor signals 310, or to update a threshold value in threshold value storage 306. If the decision is to advance the filter, then a signal is transmitted to filter drive mechanism 308 to advance the filter. Then a counter of the number of times the filter has been advanced is incremented and parameter processor 310 continues to monitor the sensors and produce parameters indicative of filter use.

Thus, embodiments of the invention may receive temperatures associated with different hardware elements of a system. The temperatures are dependent upon airflow and heating patterns of the different hardware elements. Differences between the received temperatures and expected temperatures are detected. Embodiments may also receive air pressure readings associated with different regions of air flow. Differences between measured air pressure and expected air pressure may then be detected. The airflow and heating patterns associated with a hardware element of the system are thus determined and analyzed. For example, embodiments may collect temperature readings from temperature sensors within an enclosure of the system and identify an upward temperature gradient. Then, for a given detected airflow in a region where an upward temperature gradient exists, the filter or filters that supply primary air flow components to the region may be caused to advance.

In one embodiment, monitoring mechanism 130 generates the control signal for driving drive mechanism 115. This control signal is then transmitted to drive mechanism 115 by way of I/O device 125. In another embodiment, circuitry for generating the drive control signal is contained within drive mechanism 115. In this embodiment, when the threshold is reached, monitoring mechanism 130 asserts a positive (or negative) signal to the GPIO 125. This causes GPIO 125 to send a positive (or negative) signal to the circuitry of drive mechanism 115. In response, the drive mechanism circuitry generates the drive control signal which drives the supply collection mechanism 110. Thus, a signal for driving the collection mechanism to collect used filter material is provided in response to a condition indicative of filter use sufficient to warrant advancement of the filter.

In one embodiment, the driving mechanism is a simple motor, such as a rotary or linear motor. The motor has a shaft with a gear that meshes with a gear on the shaft of collection spool 110. The motor is driven in response to the drive control signal, which may be a simple sequence of pulses converted into incremental phase delay in a sinusoidal signal applied to a winding of the motor. When the motor turns, the shaft of the collection spool turns, causing the filter to be pulled across the face of the air intake and wrapped onto the shaft. The control signal may be of a predetermined duration timed to cause the length of filter taken up by the spool to be about equal to the breadth of the air intake. In this way, the filter through which air is drawn is occasionally replaced to ensure adequate air flow there through.

Note that the combination of the supply mechanism, the collection mechanism and the filter material can be contained in one integral removable cartridge that may easily be replaced when all the filter material in the cartridge has been used. In one embodiment, monitoring mechanism 130 comprises a counter to count the number of times the filter has been advanced. When the filter has been advanced the maximum number of times to deplete the supply roll, a signal is generated which may be displayed to the user by any number of means known in the art. Thus, the present invention provides automatic filter replacement, up to the limit of the amount of material supplied, when one or more conditions indicative of filter use exist.

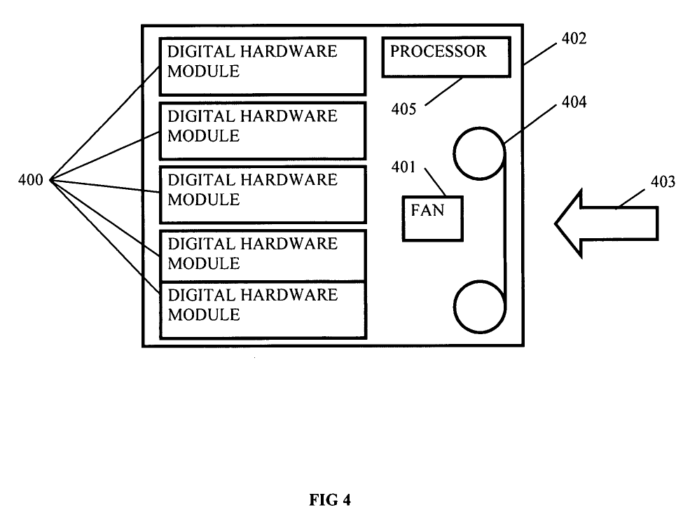

FIG. 4 shows a system of the present invention providing for monitoring, notification, and replacement of filters. A plurality of digital hardware modules 400 are provided within an enclosure 402. Sensors (not shown) are distributed in the region proximal to the modules for determining conditions surrounding the digital hardware modules. These conditions include temperature and air pressure. The digital hardware modules may include a number of elements having interrelated airflow and heating patterns. In particular, the elements may be servers, power supplies, blowers, switches, management controller, panels and the ventilation pathways thereof, in an enclosure. Each module may produce a heating pattern based upon the operations performed by the module and the type and distribution of hardware in the module. This heating pattern is measured by temperature sensors distributed within the enclosure 402. The power consumption of at least a portion of the digital hardware and elapsed time of operation is also monitored. For example, the power consumed by each of a plurality of central processing units (CPU) can be monitored and the elapsed time measured is the duration for which the CPU is powered on.

In the configuration of FIG. 4 the hardware modules 400 are all enclosed in a cabinet 402 that contains a fan 401 and drive-able filter mechanism 404. As described in detail above, the fan draws air through the filter material into the module flowing generally in the direction shown by arrow 403. Processor 405 performs the functions of parameter processor 310 and parameter analyzer 307. Processor 405 collects information from the one or more sensors distributed within the cabinet and receives consumed power and elapsed time data from the hardware. Processor 405 comprises decision logic and processing circuitry to generate and analyze parameters based on data from the sensors to make a decision when to advance the filter. Note that the number of times the filter can be advanced is computed for a given length of filter material supplied. The processor also counts the number of times the filter has been advanced. This enables computation of the number of times remaining that the filter can be advanced.

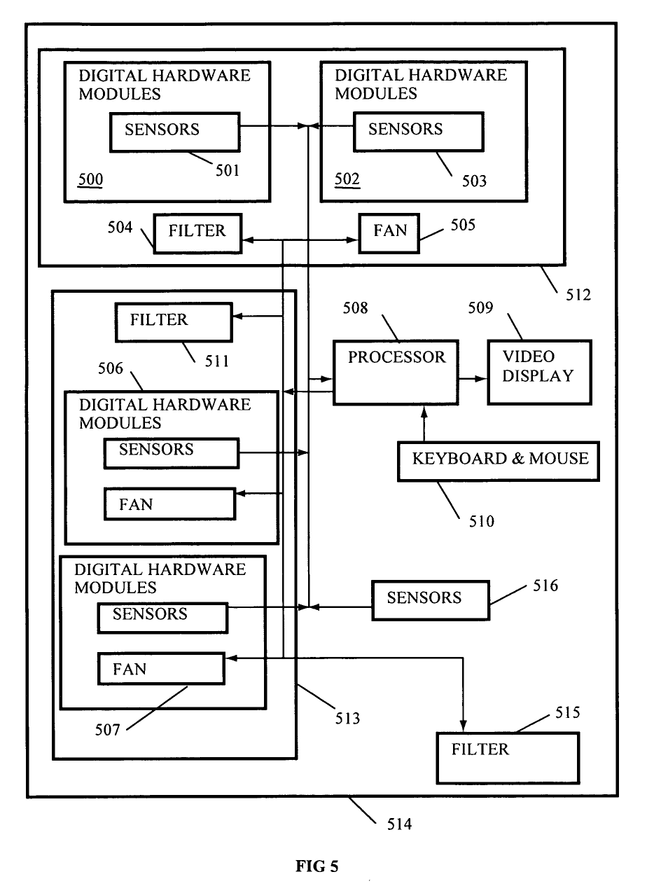

FIG. 5 shows a more complex configuration. Modules 500 and 502 are in one enclosure 512 and modules 506 and 507 are in another enclosure 513. Each enclosure has an air intake. Modules 500 and 502 are serviced by filter 504 and fan 505. Each of modules 506 and 507 are serviced by separate fans but share a common filter 511. Each enclosure 512 and 513 are enclosed within a room 514. The room is serviced by one or more filters 515. Sets of sensors are distributed about the system enclosed by enclosures 512 and 513. These include temperature and air pressure sensors. Each set of sensors is associated with a different set of hardware modules.

A processor 508 receives signals from the sensors distributed about the system within room 514. Processor 508 analyzes the parameters derived from the sensor data and makes a decision whether and when to advance a filter, and makes a decision about which filter(s) to advance. When a decision is made to advance a filter, processor 508 issues an ADVANCE FILTER command causing one or more filters to advance. The decision of which filter to advance depends on the sensor data. For example, if either sensor set 501 or sensor set 503 provides data indicative of filter use, filter 504 may be advanced. Similarly, if either sensor set within enclosure 513 provides data indicative of filter use, filter 511 may be advanced. But if all sensor sets indicate a need for filter replacement, filter 515 may be advanced. Moreover, other sensors 516 that are exterior to enclosures 512 and 513 and interior to room 514 may be distributed about the room. A decision whether to advance filter 515 may depend upon data from sensors 516.

Note that correct operation of the sensor-based filter replacement system of the present invention does not depend upon the quality of the filter material supplied by the supply mechanism. Suppose, for example, that a high quality of filter material is used. Then, more frequent filter replacement will need to occur because a high quality filter is one that becomes clogged sooner. But this will cause the sensors to provide data indicating more frequent filter replacement. Thus, the system automatically adapts to the quality of filter employed.

A video display 509 displays information concerning the status of the system. Display 509 may display, for example, a diagram of the spatial locations of each sensor and each filter mechanism and also display their status. This allows the user to monitor the status of the hardware as indicated by the sensors in each location. This also allows the user to monitor the status of each filter, including data concerning the amount of unused filter remaining on the collection supply mechanism or the amount of hours remaining before the filter cartridge needs replacement. The amount of filter remaining on the supply spool can be determined from knowing the total length of the filter and the number of times it has been advanced. Thus, when the filter has been advanced for the last time, video display 509 will display a message indicating the filter cartridge needs replacement. In this way, the user can monitor the system diagnostically and predict filter replacement based on measurable criteria.

Further, the user may be given control to cause any one of a plurality of filters in the system to advance upon user command communicated to processor 508 by keyboard and mouse 510. In such an embodiment, the command generated by processor 508 in response to the user input will cause advancement of the selected filter. This enables the user to perform diagnostics of the system and determine the effect upon system operation of the replacement of a given filter. For example, sensors 303 and 304, as shown in FIG. 3, may indicate low air pressure and high temperature in a particular region of the hardware. In response, the user may cause a particular filter to advance. The user may then observe whether the filter replacement has modified the measured air pressure and temperature. Thus, in an embodiment of the invention, interactive condition monitoring and filter maintenance is possible.

Thus, the present invention provides a method for controlling the filtering of air that flows through one or more air intakes to communicate filtered air to the interiors of cabinets that house digital hardware. One or more parameters indicative of filter use are monitored and a signal is generated in response to an indication from the parameters that filter replacement is needed. A filter collection device is driven in response to the signal causing used filter material to be collected and unused filter material from a supply of filter material to be drawn across an air passage.

Although the present invention and its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for filtering air that flows through an air intake for a cabinet that houses digital hardware, the method comprising:
monitoring a parameter indicative of filter use;
generating a signal in response to a value of the parameter associated with a time for filter replacement; and
driving the filter in response to the signal to collect a used filter material and to position an unused filter material across an air path from the air intake to attenuate an accumulation that restricts heat dissipation from the digital hardware.

2. The method of claim 1, wherein monitoring the parameter comprises determining a value for an elapse of time since positioning an unused filter across the path.

3. The method of claim 1, wherein monitoring the parameter comprises determining a value related to an amount of power consumption by the digital hardware.

4. The method of claim 1, wherein monitoring the parameter comprises determining a value for a temperature interior to the cabinet.

5. The method of claim 1, wherein monitoring the parameter comprises determining a value for an air pressure within the cabinet.

6. The method of claim 1, wherein the generated signal is in response to a comparison of a parameter indicative of filter use to a threshold value to determine whether to replace the filter material.

7. The method of claim 1, wherein the generated signal is in response to a comparison of a combination of values of monitored parameters to one or more threshold values to determine whether to replace the filter material.

8. The method of claim 1, wherein the combination of values is a weighted sum of those values.

9. The method of claim 1, wherein driving the filter comprises rotating a shaft to unroll the filter material from a roll of unused filter material.

10. An apparatus for filtering air that flows through an air intake for a cabinet that houses digital hardware, the apparatus comprising:
a filter supply mechanism to supply an unused filter material;
a filter collection mechanism to collect a used filter material;
a monitor to monitor a parameter and to process a value of the parameter to generate a signal that is indicative of a time for filter replacement; and
a drive mechanism responsive to the signal to drive the filter collection mechanism to collect used filter material and to position the unused filter material across an air path from the air intake to attenuate an accumulation that restricts heat dissipation from the digital hardware.

11. The apparatus of claim 10, wherein the filter supply mechanism comprises a first roll coupled with a first shaft to supply the unused filter material across the path and the filter collection mechanism comprises a second roll coupled a second shaft to collect the used filter material.

12. The apparatus of claim 10, wherein the monitor comprises a parameter analyzer to generate the signal based upon a comparison of an amount of consumed power by the digital hardware against a threshold power consumption, wherein the value of the parameter is the amount of consumed power.

13. The apparatus of claim 10, wherein the monitor comprises a parameter analyzer to generate the signal based upon a comparison of an elapsed time against a threshold elapsed time associated with filter use, wherein the value of the parameter is the elapsed time.

14. The apparatus of claim 10, wherein the monitor comprises a parameter analyzer to generate the signal based upon a comparison of a temperature interior to the cabinet against a threshold temperature indicative of filter use, wherein the value of the parameter is the temperature.

15. The apparatus of claim 10, wherein the monitor comprises a parameter analyzer to generate the signal based upon the value and one or more values associated with other monitored parameters.

16. The apparatus of claim 10, wherein the monitor comprises decision logic to determine whether to drive the filter supply mechanism and the filter collection mechanism to replace the used filter material with unused filter material based upon the signal.

17. A system for replacing filter material across an air intake of a cabinet for digital hardware, the system comprising:
a filter mechanism located near the air intake to position a length of a filter material across an air path to capture particulates in the air and to replace used lengths of the filter material in response to a replacement signal;
sensors within the cabinet to provide values for parameters related to use of the length of the filter material; and
a processor coupled with the sensors to process the values to determine when to replace the length of the filter material, and to generate the replacement signal to instruct the filter mechanism to replace the length of the filter material.

18. The method of claim 17, wherein the filter mechanism comprises a filter collection mechanism and a filter supply mechanism contained within a removable cartridge.

19. The method of claim 17, wherein the processor is adapted to provide an indication when a supply of the filter material within the filter mechanism is depleted.

20. The method of claim 17, wherein the sensors comprise one or more temperature sensors.

21. The method of claim 17, wherein the sensors comprise one or more power consumption indicators for the digital hardware.

22. The method of claim 17, wherein the processor comprises decision logic to evaluate a weighted combination of the values to determine when to replace the length of the filter material.

23. The method of claim 17, wherein the processor comprises a parameter analyzer to compare the values against threshold values to quantify use of the length of the filter material.
